(19) United States
(12) Patent Application Publication
(10) Pub. No.: US 2025/0244023 A1
(43) Pub. Date: Jul. 31, 2025

(54) Food Warming System Utilizing Repurposed Air From Cooking Vents

(71) Applicant: Budderfly, Inc., Shelton, CT (US)

(72) Inventors: Lee Tony Kaufman, Grafton, MA (US); Kenneth Buda, Scarsdale, NY (US)

(21) Appl. No.: 18/545,509

(22) Filed: Dec. 19, 2023

Related U.S. Application Data
(60) Provisional application No. 63/434,731, filed on Dec. 22, 2022.

(51) Int. Cl. F24C 15/20; A47J 36/24

(52) U.S. Cl. CPC F24C 15/20; A47J 36/24

(57) ABSTRACT

A system and method of recycling heat from a cooking vent by circulating exhaust gasses captured by the vent through a warming element via fluid conveying elements and releasing the exhaust gasses back into the vent for expulsion to the outside environment, preferably the system and method are used in a restaurant, preferably a quick serve restaurant where food is cooked and kept in warming areas prior to serving to customers.

### FIELD OF THE INVENTION

The present invention relates to systems and methods for repurposing the heat from kitchen exhaust vents to a system used for keeping food warm after the cooking process up until the time it can be served to customers. Of further benefit is the ability to replace or limit the use of the high energy heating lamps used to keep food warm.

### BACKGROUND OF THE INVENTION

Fast food restaurants also known as quick serve restaurants (QSR), can serve clients quickly by preparing food in advance. This food must be kept warm, and within reach of those that serve customers coming into the restaurant or going through a drive through pickup area.

It is common practice to use relatively high-powered heating lamps to keep food warm after it has been cooked and packaged.

Typically, a rack with hearing lamps is placed in proximity to the grill where cooks will prepare the food. The food then gets packaged in a preparation area after which the ready-to-serve food gets placed on the warming rack. On the other side of the rack, servers pick up the food to fulfill orders coming in from walk-in or drive-up customers.

Since QSRs typically have a high volume of orders at peak periods, the layout of the QSR is carefully designed to maximize efficiency. However, the layouts that provided the greatest efficiency for product throughput is not the best layout for energy consumption. In particular, the serving area and warming areas cannot be enclosed to maintain the heat generated by the equipment and thus a relatively large amount of heat escapes into the environment. Both sides of the rack must be kept open due to the high volume of traffic and the required access to fill the serving station from the grill and preparation side as well as the serving side.

This leads to a large amount of heat being expelled into the interior environment and increasing the temperature of the room, which in turn, causes the HVAC equipment to have to work harder to keep the room at a setpoint temperature. Often, the temperature near the grill and serving area is uncomfortably warm for those working there.

Additionally, hot air is generated by the grill and exhausted out a vent to the outside. This results in a situation where energy from the grill is wasted (vented), and energy from the heat lamps is wasted (dispersed in the interior space), and energy from the HVAC is being wasted, especially when necessary to remove the heat dispersed in the interior space.

It would be advantageous to reduce the wasted energy seeing as the cost of energy continues to rise and the lowering of the carbon footprint of a business advantageous. While QSRs have been in existence for many decades, no one has really analyzed the relatively large waste of energy these businesses face dictated by the engineered layout of the food preparation process. It would be beneficial if a system could utilize hot exhaust air from the vents and use pipes and ducts to direct the energy to warming devices where pre-prepared food can be placed.

One issue with using the energy dispersed by the grill is that the energy will only be generated (and dispersed) when the grill is in use. However, it is anticipated that while the grill is operational making food, the food warmer will be required to keep food warm. Alternatively, when the grill is not working, it is unlikely that prepared food will remain in the food warmer for long. Likewise, residual temperature kept by the stainless-steel warmers employed as the food warmers will remain hot for a relatively long time due to heat absorption of the device, which will function to keep the food warmed even after the heat supply has been interrupted.

Various systems have sought to employ energy recapture systems, however the various systems have not proved to be practical in implementation or design. For example, U.S. Patent No. 10,101,037 (the '037 Patent) entitled “Energy Recovery Devices, Systems and Methods” describes the extraction of waste heat from exhaust fumes. However, the '037 Patent does not directly use the flue gasses to warm items, rather a heat exchanger warms a heat-exchange fluid which fluid is then used in a load or thermal storage device.

Additionally, U.S. Pat. No. 10,808,945 (the '945 Patent) entitled “Energy Recovery Devices, Systems and Methods” also describes a system using a heat exchanger built into a recess of the exhaust hood and this heat exchanger uses heat exchanger fluid which fluid is different from the exhaust gasses. Thus, this patent fails to contemplate use of the exhaust gasses to heat the warming tray/area for food.

Still further, U.S. Patent No. 11,149,960 (the '960 Patent) entitled “Exhaust Hood Energy Recovery Device” uses a series of fluid filled panels that are used to recover thermal energy that can be used to rewarm the fresh makeup air returning to the kitchen. Similar to the other patents referenced above, the heat exchanger heats a heat exchanger fluid which is then used to warm the air. The exhaust gases are not used to directly warm the area the recovered heat is being directed at.

While the above systems have sought to reclaim energy, when applied to a QSR, the layout of the space is critical for food preparation efficiency. This means that any such system will have to be installed in a manner that does not interfere with the engineered layout and works within the tight space restrictions of QSRs.

It would be highly beneficial to have a system that is easy to install, and easy to implement in the tight confines of a QSR without having to add complex piping or assemblies into the duct or vent/hood system.

It would also be beneficial to have an alternate source of heating for food warming to replace the high energy heating lamps currently used in QSRs.

Therefore, a system that can reutilize the vent exhaust heat and use that energy to keep food warm without added expense of employing heaters would be highly desirable

### SUMMARY OF THE INVENTION

It is therefore desired to provide a system and method that reuses or employs hot air being expelled from food vents such that the heat is reused to replace the high-energy consuming heating lamps currently used to warm prepared food in a quick serve restaurant (QSR) environment.

In one configuration, heated exhaust gasses may be pulled from the vent with a fan and directed into piping, which leads to stainless steel hollow warming trays that are placed on a rack upon which food is placed. The hot exhaust gasses circulating through the stainless-steel boxes warms the food, thus keeping the food placed on these warming trays hot until it is served. In one configuration, the warming trays may be rectangular in the shape of rectangular boxes.

It is contemplated that the gasses circulated through one or more of these warming devices may be accomplished using a fan and returned to the vent where it may be expelled.

Additionally, to anticipate the last batch of prepared food being kept warm longer, thermostats may be employed that can trigger secondary warming systems such as warming lamps or other sources of heat to warm the food in the rack. However, it is contemplated that these can be used very sparingly. Recycling that heat and using it for warming the food will significantly reduce the cost of using the high-powered heating lamps. The enclosed system that warms the food from the bottom up will also heat the surrounding air less than a radiant heater.

The installation of the system is intended to be simple with limited or no added complicated vents, filters, or mounted coils into the air duct area. This is critical in QSRs where space and equipment operational efficiency is very important.

The exhaust gasses described herein can vary depending on what type of cooking/heating is being employed and may contain particles and various mixtures of gasses or may be primarily heated air with e.g. grease/vaporized oils/fats. For example, a vent hood over a gas stove/grill would be expected to contain different mixtures of gasses/particles than e.g. a hood over a griddle or a deep fryer. The gas stove/grill gasses would be expected to be a larger percentage of combustion byproducts whereas a griddle would be expected to be largely heated air and a vent over boiling water may have a larger percentage of steam.

In one configuration, small holes may be drilled into both sides of the existing vent. From this, a narrow tube may be inserted and attached to a fan that pulls air out and into a set of piping. It is contemplated that the piping can be flexible.

In another configuration, a clipped-on tube that snakes around the vent into the interior to pull in the air can be employed to avoid the drilled holes.

Additionally, a filter with relatively large openings to not dramatically restrict air flow, may be used on the opening to trap any grease or particles that could clog the piping. In essence, the installation of the system is as simple as drilling small inlet and outlet holes into the hood of the grille. It can also be attached under the grille with a clip to avoid drilling. Ultimately the air is pulled out with an embedded fan from one side of the grille, circulated through tubing to the stainless steel for warming plates and the returned to the other side of the vent where the built-in fan exhausts the air to through the exhaust vent.

In an alternate configuration, the heat of the exterior metal or stainless-steel surface can be captured by the fan pulling air over that vent surface without direct exhaust air with contaminants being used or pulled in. In this manner, duct work may connect to the vent hood such that the pulled in air must pass along the vent surface to warm up prior to reaching the warming station. While such a system will take longer to warm up, for some applications where grills and cooking stations are working around the clock, this can be as efficient and require less cleaning and filter replacement or cleaning.

In yet another alternate configuration, a liquid can be circulated through the tubing instead of air, with the temperature of the heat vent used to increase the temperature of the liquid.

The piping can be installed to traverse the ceiling and descend near the food warming area, where it may be attached to a food warming box. The warming box may be provided with piping in the form of coils to maximize path of heat and therefore maximize the heat extraction to the surface of the food warming box. It is contemplated that the food warming box may be provided as stainless steel, which provides good thermal properties and is resistant to corrosion.

In another configuration, the stainless-steel box used is provided with an open hollow interior and the hot air is passed through the entire interior cavity without the use of coils. Various heat sinks could be provided in the interior cavity that are designed to slowly absorb the heat and slowly release heat if the heating source is interrupted.

The air may be extracted from an opposite side of the heating box from where it entered and returned to the vent after which it is expelled.

It will be understood that when the grill is operating, hot air is being generated and subsequently expelled. A thermostat may be used so that if the heating box does not get warm enough, supplementary heating sources maybe be temporarily employed until the temperature setpoint of the thermostat is reached.

Such a thermostat can also be used to turn on alternate sources of heat should the heat source stop while food remains on the stations to keep the last food products warm longer and to ensure compliance to food safety requirements.

It is also desired to provide a system and method that can reutilize the exhaust air being expelled from the vent. This exhaust air is currently sent to the exterior through a vent that has a fan creating suction pulling the air upwards and through exhaust vents to the exterior. The system, through a small hole in the vent or a clipped on adapted tube ingress point (or by using the alternate structures described above) pulls a small portion of this hot air out through a series of tubing to use the heated air to warm the stainless-steel food warming trays.

It is further desired to provide a system and method that can warm food that has been prepared and wrapped and is waiting to be served. The current methods employ heat lamps that are both energy inefficient and also generate ambient heat that affects the environment causing the HVAC to work harder to overcome the additional generated heat.

It is still further desired to provide a system and method that can use piping to circulate the hot air extracted from the vent through a series of pipes with a fan, returning it to the duct to be expelled. The piping can be metal or high temperature plastic or tubing which can easily be run. It is an object of the present invention to provide a system that can replace the current heating lamps thus eliminating the energy cost of these as well as the generated ambient heat. Instead, the heat is directed through the tubing to stainless steel food warmers which give off less ambient heat and fulfil the food heating function.

Therefore, these and other objects of the invention are achieved by providing a food warming system including a fluid conveying element configured to connect to a cooking exhaust vent in order to receive heated exhaust gasses. A fan is positioned in or adjacent to the fluid conveying element, the fan configured to move the heated exhaust gasses through the fluid conveying element. A warming element is positioned remote from the cooking exhaust vent, the warming element is configured to connect to the fluid conveying element to receive the heated exhaust gasses moved by the fan such that the heated exhaust gasses warm the warming element and the heated exhaust gasses become cooled exhaust gasses. An outlet on the warming element is configured to connect to a second fluid conveying element, the second fluid conveying element configured to allow the cooled exhaust gasses move back to the cooking exhaust vent for exhaustion via the vent.

In certain aspects a screen is positioned before the fan. In other aspects a filter is positioned before the fan. In still other aspects a controller is connected to a temperature sensor, the temperature sensor reading a temperature of the exhaust gasses prior to the exhaust gasses warming the warming element and if the temperature is above a threshold value, the controller activating the fan. In further aspects, prior to activating the fan, the controller determines if the warming element is below a second threshold temperature and if below said second threshold temperature, the controller activates the fan. In still other aspects a deflection element is positioned within the fluid conveying element and between the exhaust vent and the fan.

The fan is also turned off with the thermostat, and the pump in liquid systems, to avoid pumping or forcing cooler air through the system when cooking stops and allowing the residual heat to remain in the system longer.

In further aspects a recess is positioned below the deflection element, and the recess is configured to be opened for cleaning. In further aspects, the system includes a cooking element positioned below the exhaust vent and the exhaust vent comprises a vent hood with the fluid conveying element connected to the vent hood. In still other aspects the fan is removable from the fluid conveying element so that blades of the fan can be exposed for cleaning. In yet other aspects the warming element includes a chamber with an inlet and an outlet, the inlet configured to connect to the fluid conveying element and the outlet configured to connect to the second fluid conveying element. In still other aspects the warming element includes one or more dividers which separate one or more food items placed on the warming element from other food items placed on the warming element. In yet other aspects a controller is configured to activate a second heating element which is an electric or combustion heating element adjacent the warming element when a temperature of the exhaust gasses are below a threshold temperature. In certain aspects the second heating element is activated based on one or more time limits. Further the flow of cooling air is also stopped as the second heating source is activated.

In further aspects a method of warming food is provided including one or more steps of: moving heated exhaust gasses with a fan from a cooking exhaust vent via a fluid conveying element to a warming element; heating the warming element with the heated exhaust gasses by introducing the heated exhaust gasses into a chamber of the warming element to thereby allow the warming element to extract heat from the heated exhaust gasses such that the heated exhaust gasses become cooled exhaust gasses; and returning the cooled exhaust gasses to the exhaust vent.

In certain aspects the cooled exhaust gasses are vented via the exhaust vent to an external environment. In other aspects a screen is positioned such that the screen is configured to have the exhaust gasses pass through the screen prior to the fan. In still other aspects a filter is positioned such that the filter is configured to have the exhaust gasses pass through the filter prior to the fan. In other aspects the fluid conveying element is a pipe.

Other objects of the invention and its features and advantages will become more apparent from consideration of the following drawings and accompanying detailed description.

### BRIEF DESCRIPTION OF THE DRAWINGS

FIG. 1 shows the added components a food warming system using exhaust vent air being deployed in a kitchen.

FIG. 2 shows one example of a food warming tray according to FIG. 1.

FIG. 3 shows an alternate example of a food warming tray according to FIG. 1.

FIG. 4 is a block diagram showing an example control system for the warming system of FIG. 1.

FIG. 5 shows example control logic implemented by the control system of FIG. 4

### DETAILED DESCRIPTION OF THE DRAWINGS

Referring now to the drawings, wherein like reference numerals designate corresponding structure throughout the views.

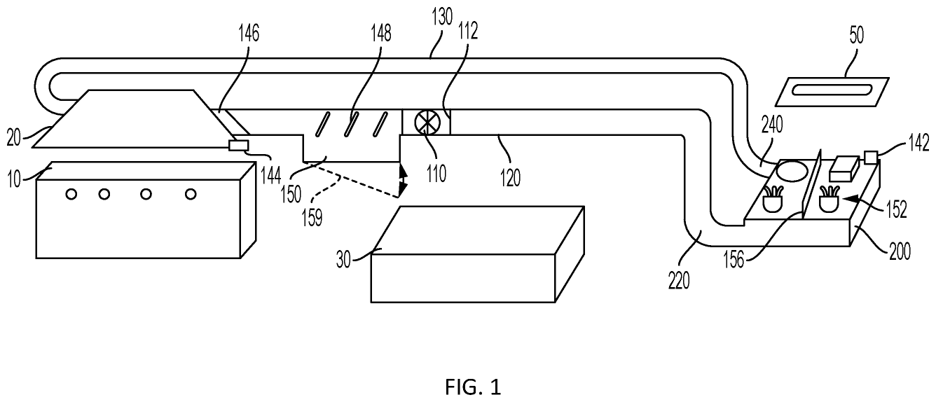

FIG. 1 shows components in a food warming station and the food preparation environment. Cooking area 10 is shown which is typically a grill area or other food cooking area. On top of the grille an exhaust vent 20 is shown, which pulls air out via a fan to the outside through the exhaust vent.

Prepared food is moved 12 from the cooking area to wrapping area 30 where the prepared food is seasoned, assembled, and packed or wrapped into ready to serve packages.

The prepared food is then moved to a warming/serving area 40 where it is warmed by one or more heating lamps 50. In most cases, the moving is done by restaurant workers, but may be done by machinery in whole or in part.

It should be noted that there can be a number of heating lamps and the warming or serving area may be multiple layers high. The various components can be positioned differently, and the example shown is not meant to be limiting but simply an example representation of a possible configuration.

As shown in FIG. 1, various components are provided to extract the residual heat from the vent 20 and bring it to the warming/serving area 40. Fluid conveying passages which may be piping 120 is attached to the exhaust vent 20 and a fan 110 is used to pull hot air out of the vent 20 and along the inside of the piping 120 to the warming/serving area 40 where it enters a warming tray 100.

A thermostat 140 is added to the heating lamps so that they do not have to function while the warming tray 100 keeps the warming/serving area 40 at the appropriate temperature.

The air comes out of the warming tray 100 through fluid conveying passages which may also be piping 130 and returns to the exhaust vent 20 from which it is expelled. The fan 110 is preferably positioned after the screen/filter 146 so that this screen/filter 146 can reduce grease/oil being brought into the piping 120. Furthermore, a trap 150 can be provided with a door that opens 154 for cleaning. The trap can utilize deflectors 148 which attract/remove further grease/oil from making its way to the fan 110 and which deflectors 148 may allow the grease/oil to drip into the trap 150. The fan 110 may also be removable at the seams 112 or otherwise removable to allow the fan 110 to be cleaned periodically.

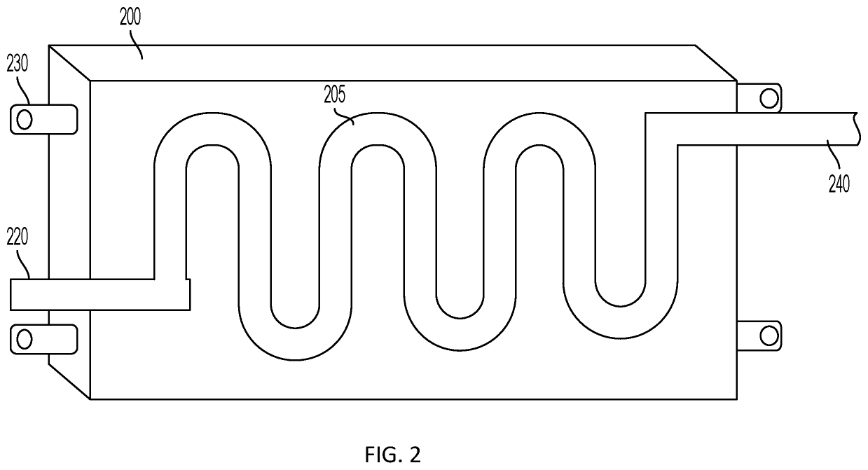

Turning now to FIG. 2 we show a warming tray 200 which is attached to the serving/warming area with mounts 230. The hot air comes into device 200 through an inlet pipe 220 and circulated through the internal chamber, in this case, internal piping 205 warming the outside of the tray 200 as it traverses. The hot air exists the warming tray 200 from an exit port 240.

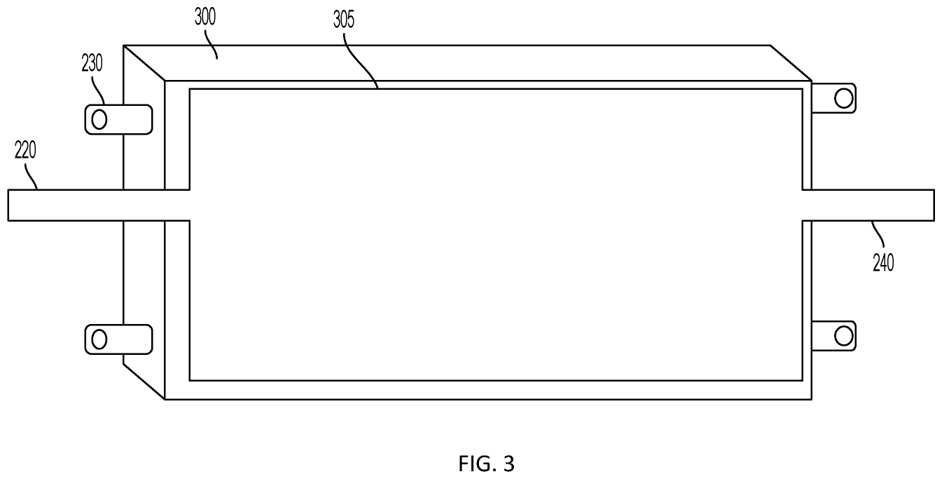

Turning now to FIG. 3 an alternate model of the warming tray 300 is depicted where the inlet pipe 220 feeds into a hollow area 305 of the alternate warming device 300. The whole interior of the warming tray 300 is subjected to the hot air which exits from the exit port 240.

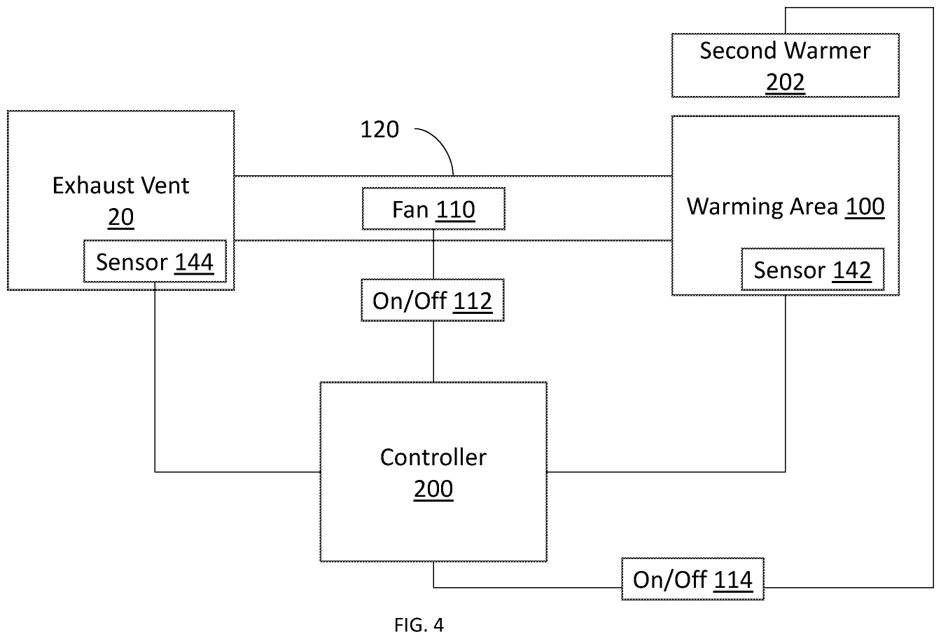

FIG. 4 shows an example control system architecture where a controller 200 is connected to sensors 144/142. Sensor 144 is positioned so as to read the temperature of exhaust gasses entering or within the exhaust vent 20. The warming area 100 also includes a temperature sensor 142 which allows the controller to determine if heating is required. If the sensor 144 reads below a threshold temperature, the controller 200 then knows that there is insufficient heat to warrant activation of the fan 110. In such a scenario, if warming is required, a second warmer 202 may be activated. This second warmer may be e.g. an electric heater such as a heat lamp or a combustion based heater that can be turned on/off 114 by the controller as appropriate. If the sensor 144 indicates sufficient heat, the fan 110 can be turned on 112 if the sensor 142 indicates that heat is required at the warming area 100. The controller 200 may be programmed with or may receive instructions via a network to include one or more time limits/thresholds that limit the second warmer 202 being turned on. For example, if outside known or expected hours of operation of the kitchen, the controller will not turn the second warmer 202 on. Manual override options may also be provided.

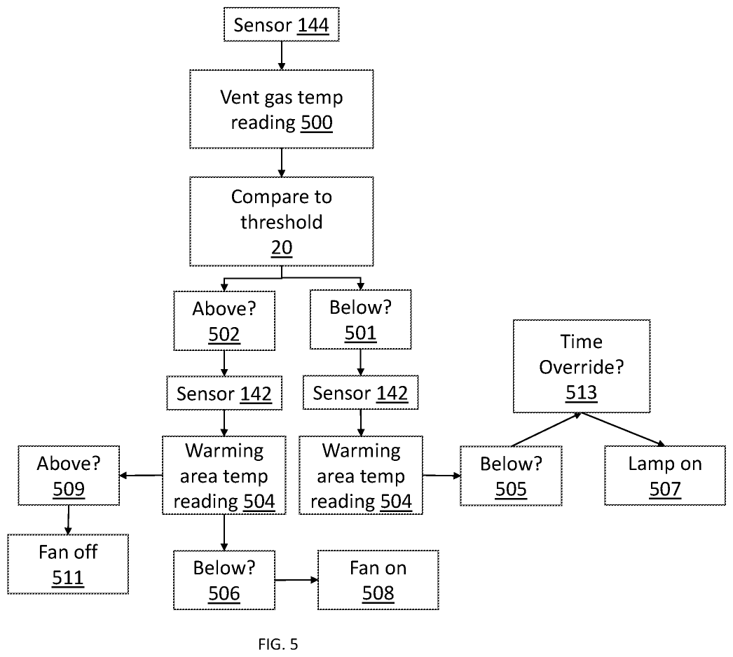

FIG. 5 shows further details of the control logic. As shown, sensor 144 reads the vent gas temperature 500 and compares to the threshold 20. If above 502, the sensor 142 is used to determine the warming area temperature reading 504. If the warming temperature is above a second threshold 509, the fan is turned off/remains off 511. If the warming area temperature is below 506 the second threshold, the fan is turned on 508 to warm the warming area with the heated exhaust vent gasses. Turning back to the initial threshold comparison, if the vent gas temperature is below 501 the threshold, this indicates the cooking element may not be on and thus, moving fluid (e.g. air) through the system would cool the warming area and thus would not be indicated. In this case, the fan would remain or be turned off. If based on the sensor 142 reading, the warming area temperature 504 is below 505 the threshold the second warmer (e.g. lamp) will be turned on 507 unless there is a time override 513. The time override can be scheduled based on hours of operation of the kitchen.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A food warming system comprising:
a fluid conveying element configured to connect to a cooking exhaust vent in order to receive heated exhaust gasses;
a fan positioned in or adjacent to the fluid conveying element, the fan configured to move the heated exhaust gasses through the fluid conveying element;
a warming element positioned remote from the cooking exhaust vent, the warming element is configured to connect to the fluid conveying element to receive the heated exhaust gasses moved by the fan such that the heated exhaust gasses warm the warming element and the heated exhaust gasses become cooled exhaust gasses;
an outlet on the warming element configured to connect to a second fluid conveying element, the second fluid conveying element configured to allow the cooled exhaust gasses move back to the cooking exhaust vent for exhaustion via the vent.

2. The system of claim 1 further comprising a screen positioned before the fan.

3. The system of claim 1 further comprising a filter positioned before the fan.

4. The system of claim 1 further comprising a controller connected to a temperature sensor, the temperature sensor reading a temperature of the exhaust gasses prior to the exhaust gasses warming the warming element and if the temperature is above a threshold value, the controller activating the fan.

5. The system of claim 4 wherein prior to activating the fan, the controller determines if the warming element is below a second threshold temperature and if below said second threshold temperature, the controller activates the fan.

6. The system of claim 1 further comprising a deflection element positioned within the fluid conveying element and between the exhaust vent and the fan.

7. The system of claim 6 further comprising a recess positioned below the deflection element, wherein the recess is configured to be opened for cleaning.

8. The system of claim 1 wherein the system further comprises a cooking element positioned below the exhaust vent and the exhaust vent comprises a vent hood with the fluid conveying element connected to the vent hood.

9. The system of claim 1 wherein the fan is removable from the fluid conveying element so that blades of the fan can be exposed for cleaning.

10. The system of claim 1 wherein the warming element includes a chamber with an inlet and an outlet, the inlet configured to connect to the fluid conveying element and the outlet configured to connect to the second fluid conveying element.

11. The system of claim 1 wherein the warming element includes one or more dividers which separate one or more food items placed on the warming element from other food items placed on the warming element.

12. The system of claim 1 further comprising a controller configured to activate a second heating element which is an electric or combustion heating element adjacent the warming element when a temperature of the exhaust gasses are below a threshold temperature.

13. The system of claim 12 wherein the second heating element is activated based on one or more time limits.

14. A method of warming food comprising:
moving heated exhaust gasses with a fan from a cooking exhaust vent via a fluid conveying element to a warming element;
heating the warming element with the heated exhaust gasses by introducing the heated exhaust gasses into a chamber of the warming element to thereby allow the warming element to extract heat from the heated exhaust gasses such that the heated exhaust gasses become cooled exhaust gasses;
returning the cooled exhaust gasses to the exhaust vent.

15. The method of claim 14 wherein the cooled exhaust gasses are vented via the exhaust vent to an external environment.

16. The method of claim 14 further comprising a screen positioned such that the screen is configured to have the exhaust gasses pass through the screen prior to the fan.

17. The method of claim 14 further comprising a filter positioned such that the filter is configured to have the exhaust gasses pass through the filter prior to the fan.

18. The method of claim 14 wherein the fluid conveying element is a pipe.
